(19) United States
(12) Patent Application Publication
(10) Pub. No.: US 2014/0184011 A1
(43) Pub. Date: Jul. 3, 2014

(54) Stator for Rotating Electrical Machine and Rotating Electrical Machine

(71) Applicants: Tomoaki Kaimori, Hitachinaka-shi (JP); Yoshimi Mori, Hitachinaka-shi (JP); Takahiro Omori, Hitachinaka-shi (JP); Takeshi Matsuo, Hitachinaka-shi (JP); Yasuyuki Saito, Hitachinaka-shi (JP)

(72) Inventors: Tomoaki Kaimori, Hitachinaka-shi (JP); Yoshimi Mori, Hitachinaka-shi (JP); Takahiro Omori, Hitachinaka-shi (JP); Takeshi Matsuo, Hitachinaka-shi (JP); Yasuyuki Saito, Hitachinaka-shi (JP)

(73) Assignee: HITACHI AUTOMOTIVE SYSTEMS, LTD., Hitachinaka-shi, Ibaraki (JP)

(21) Appl. No.: 14/237,485

(22) PCT Filed: Aug. 8, 2012
(86) PCT No.: PCT/JP2012/070246

§ 371 Date: Feb. 6, 2014

(30) Foreign Application Priority Data
Sep. 7, 2011 (JP) 2011-194885

(51) Int. Cl. H02K 3/12

(52) U.S. Cl. CPC H02K 3/12
USPC 310/185

(57) ABSTRACT

A stator for a rotating electrical machine includes a stator core including a plurality of slots arrayed in a circumferential direction and a stator winding formed of a conductor having a rectangular cross section and an insulation coating. The stator winding is configured to be inserted in the slot. The stator winding includes a first, a second, and a third phase windings constituted by connecting a plurality of segment coils formed in an approximate U-shape. The stator winding also includes a first neutral wire formed of a single continuous conductor extending across a first slot and a second slot, and configured to connect the first phase winding and the second phase winding. The stator winding further includes a second neutral wire pulled out from a third slot and configured to connect the third phase winding and the first neutral wire.

### TECHNICAL FIELD

The present invention relates to a stator using a rectangular wire for a coil conductor and a rotating electrical machine including the stator.

### BACKGROUND ART

A rotating electrical machine used for driving a vehicle is required to be small sized and have high power. A rectangular wire is used to improve space factor and power, and a winding method using a rectangular wire segment is used.

In the winding method, a rectangular wire formed in a U-shape is inserted in a stator core, and each straight portion of the rectangular wire protruding from the stator core is twisted in the circumferential direction so as to be connected to a rectangular wire in different slot. In the case of a star connection, a neutral wire for connecting phase windings together is necessary. Since the shape of the neutral wire is far different from the shape of the U-shaped coil, the neutral wire needs to be routed around on a coil end. This makes the shape of the neutral wire complicated.

In the invention described in PTL 1, jumper wires, provided to connect different phases in a configuration in which coils of different phases are continuously wound, are connected to each other to constitute a neutral wire. Further, in the invention described in PTL 2, jumper wires, provided for a configuration in which coils of the same phase are continuously wound, are connected to each other to constitute a neutral wire of a star connection.

### CITATION LIST

### Patent Literatures

PTL 1: JP 2009-303420 A

PTL 2: JP 2006-50690 A

### SUMMARY OF INVENTION

### Technical Problem

However, the object of PTL 1 is mainly directed to an application for a divided core, so that an application for a rectangular wire segment is difficult. Further, in the method according to PTL 2, jumper wires, provided in a configuration in which coils of the same phases are continuously wound, are used. However, for a stator using the rectangular wire segment, windings are not continuous and a jumper wire is not provided, so that the method is not applicable.

### Solution to Problem

According to an aspect of the present invention, there is provided a stator for a rotating electrical machine including: a stator core including a plurality of slots arrayed in a circumferential direction; and a stator winding formed of a conductor having a rectangular cross section and an insulation coating, the stator winding configured to be inserted in the slot, wherein the stator winding includes a first, a second, and a third phase windings configured by connecting a plurality of segment coils formed in an approximate U-shape, a first neutral wire formed of a single continuous conductor extending across a first slot and a second slot, and configured to connect the first phase winding and the second phase winding, and a second neutral wire pulled out from a third slot and configured to connect the third phase winding and the first neutral wire.

According to an aspect of the present invention, there is provided a rotating electrical machine including: the stator for a rotating electrical machine; and a rotor which is rotatably arranged via a gap with the stator core.

### Advantageous Effects of Invention

According to the present invention, workability of connecting neutral wires and reliability of the connection can be improved.

### BRIEF DESCRIPTION OF DRAWINGS

FIG. 1 is a figure illustrating a schematic configuration of a hybrid-type electric vehicle in which a rotating electrical machine according to an embodiment is installed as a drive motor.

FIG. 2 is a cross sectional view of the rotating electrical machine illustrated in FIG. 1.

FIG. 3 is a cross sectional view taken along A-A in FIG. 2.

FIG. 4 is a perspective view of a stator 230.

FIG. 5 is a figure explaining a segment coil 240.

FIG. 6 is a figure explaining a method of removing an insulation coating of a rectangular wire.

FIG. 7 is figure illustrating a connection structure of a stator winding 238.

FIG. 8 is a figure illustrating a schematic form of a portion of a winding represented by reference sign B in FIG. 7.

FIG. 9 is a figure illustrating a shape of coil end portions 244d and 245c of neutral wires 244 and 245 pulled out to one end side of a stator core 232.

FIG. 10 is a figure illustrating a schematic view of a neutral wire 245 after forming processing.

FIG. 11 is a figure illustrating a first exemplary modification.

FIG. 12 is a figure illustrating a second exemplary modification.

FIG. 13 is a figure illustrating a perspective view of a conventional stator.

FIG. 14 is a figure explaining a connection structure of a neutral wire of the stator illustrated in FIG. 13.

### DESCRIPTION OF EMBODIMENTS

An embodiment of the present invention will be described below referring to the drawings. In a rotating electrical machine according to the embodiment, a rectangular wire is used which allows the rotating electrical machine to have high power and be small sized. Therefore, the rotating electrical machine is preferable for, for example, a drive motor for an electric vehicle. Further, the rotating electrical machine can be adopted not only for a battery electric vehicle which is driven solely by a rotating electrical machine but also for a hybrid vehicle which is driven by both an engine and a rotating electrical machine. A hybrid vehicle will be described as an example below.

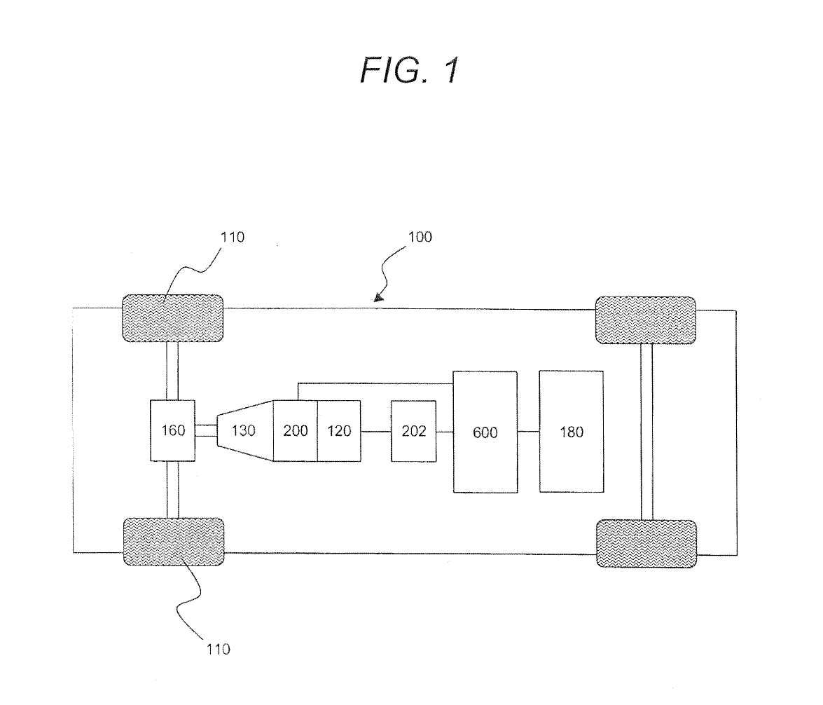

FIG. 1 is a figure illustrating a schematic configuration of a hybrid-type electric vehicle in which a rotating electrical machine according to the embodiment is installed as a drive motor. As illustrated in FIG. 1, a vehicle 100 of the hybrid vehicle is installed with an engine 120, a first rotating electrical machine 200, a second rotating electrical machine 202, and a high voltage battery 180.

The battery 180 is configured with a secondary battery such as a lithium-ion battery and a nickel-hydrogen battery which outputs high voltage DC power with a voltage as high as 250 to 600 volts or higher. The battery 180 supplies DC power to the rotating electrical machines 200 and 202 when driving force of the rotating electrical machines 200 and 202 is necessary. During regenerative drive, DC power is supplied to the battery 180 from the rotating electrical machines 200 and 202. Supplying and receiving of the DC power between the battery 180 and the rotating electrical machines 200 and 202 are carried out via a power conversion equipment 600. Although not shown in the drawing, a battery for supplying low voltage power (e.g., power for 14-volt system) is installed in the vehicle.

The rotational torque from the engine 120 and the rotating electrical machines 200 and 202 is transmitted to a front wheel 110 via a transmission 130 and a differential gear 160. Since the rotating electrical machines 200 and 202 have almost the same configuration, the rotating electrical machine 200 will be described below as a representation.

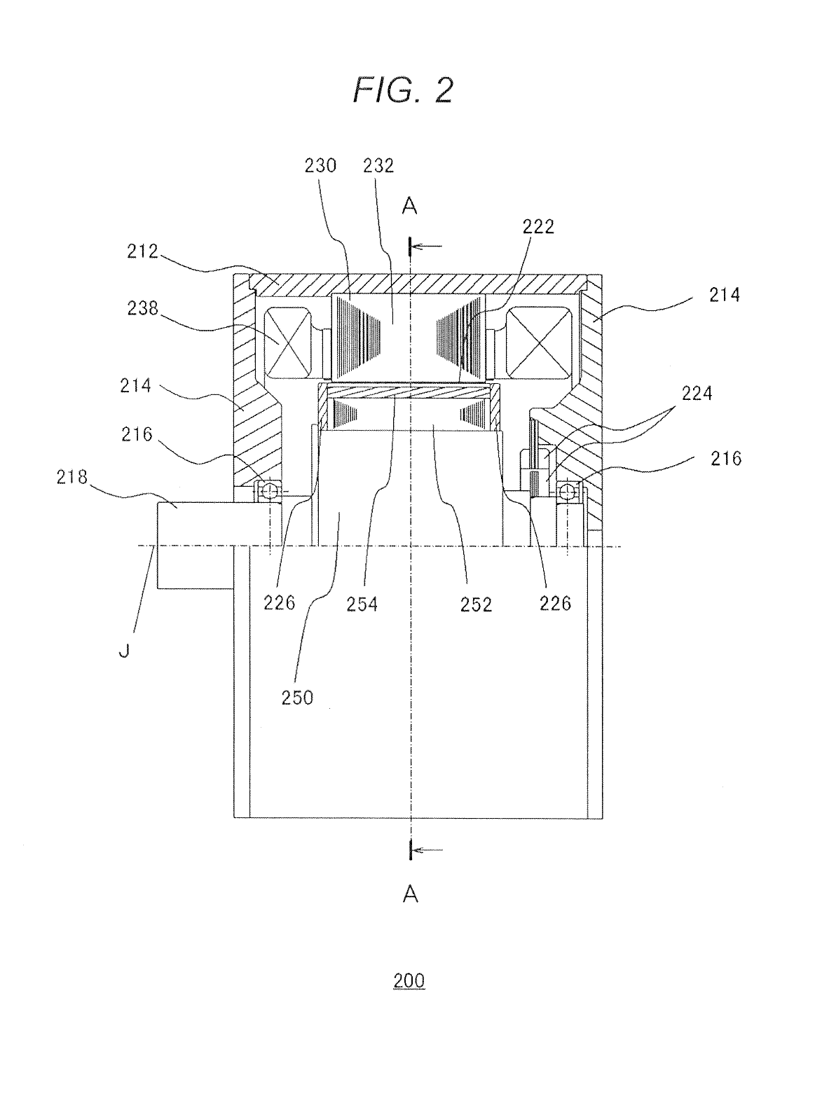

FIG. 2 is a cross sectional view of the rotating electrical machine illustrated in FIG. 1. The rotating electrical machine 200 includes a housing 212, a stator 230 supported inside the housing 212, and a rotor 250. The stator 230 includes a stator core 232 and a stator winding 238. Inside the stator core 232, the rotor 250 is rotatably supported via an air gap 222. The rotor 250 includes a rotor core 252, a permanent magnet 254, and a nonmagnetic attached plate 226. The rotor core 252 is fixed to a column-shaped shaft 218. Hereinafter, the direction along J-axis of the shaft 218 is referred to as “axial direction”, the rotational direction about the J-axis is referred to as “circumferential direction”, and the radial direction with the J-axis in the center is referred to as “radial direction”.

The housing 212 includes a pair of end brackets 214 each provided with a bearing 216. The shaft 218 is rotatably supported by these bearings 216. The shaft 218 is provided with a resolver 224 which detects a polar location or a rotational speed of the rotor 250.

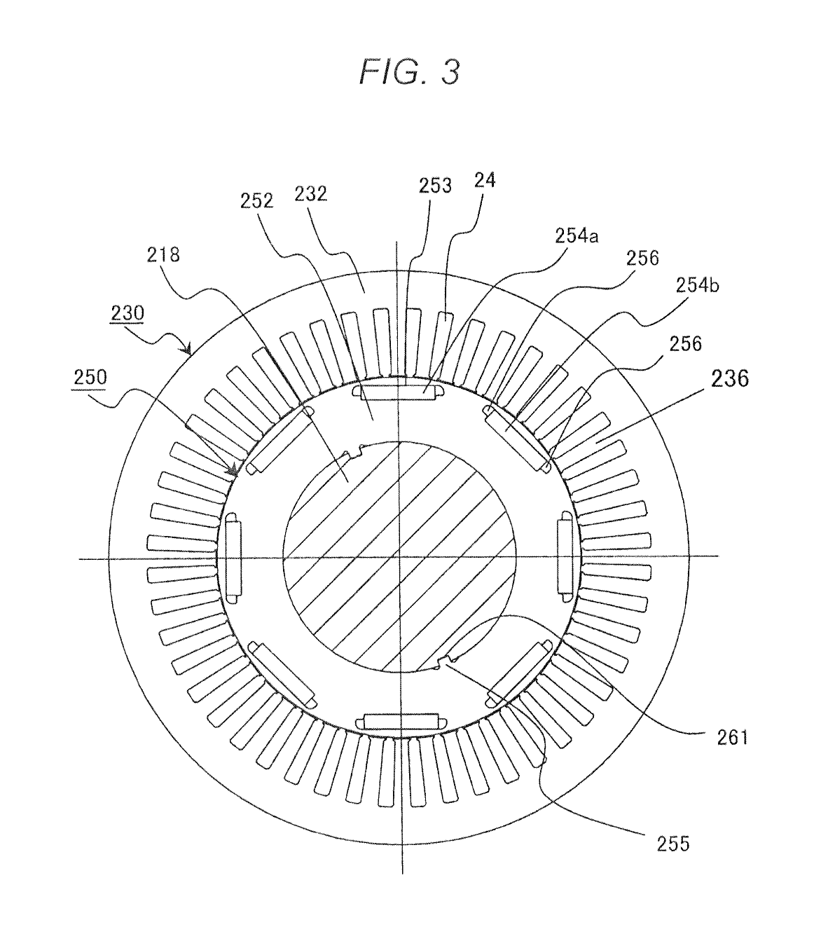

FIG. 3 is a cross section taken along A-A in FIG. 2. Note that, in FIG. 3, illustrations of the housing 212 and the stator winding 238 are omitted. A plurality of slots 24 and a plurality of teeth 236 are evenly arranged on the entire circumference of the stator core 232. In FIG. 3, reference signs are not appended to every slot and teeth. Some of the teeth and slots are appended with a reference sign as a representation. Although not shown in the drawing, phase windings of U-phase, V-phase, and W-phase are installed in the slot 24. Note that, although not shown in the drawings, an insulation member called a slot liner is arranged in the slot 24. In the embodiment, the distributed winding is employed to wind the stator winding 238.

The distributed winding is a winding method in which a phase winding is wound in the stator core 232 so as that the phase winding extends across a plurality of slots 24 to be contained in two separate slots. In the embodiment, the distributed winding is employed as the winding method so that the formed distribution of magnetic control is close to a sinusoid, which allows to obtain reluctance torque easily. Therefore, by utilizing field weakening control, reluctance torque, or the like, control can be carried out in a wide range of rotational speed not only at a low rotational speed but also at a high speed. Therefore, the embodiment is preferable for obtaining motor characteristic, for example, for an electric vehicle.

A rectangular shaped hole 253 is drilled in the rotor core 252. Permanent magnets 254a and 254b (hereinafter referred to as 254 as a representation) are embedded and fixed with an adhesive or the like in the hole 253. The width in the circumferential direction of the hole 253 is provided to be larger than the width in the circumferential direction of the permanent magnet 254. A magnetic air gap 256 is formed in both sides of the permanent magnet 254. The magnetic air gap 256 may be filled with an adhesive or integrally fixed with the permanent magnet 254 with a molding resin. The permanent magnet 254 acts as a magnetic field pole of the rotor 250.

The permanent magnet 254 is magnetized along the radial direction and the direction of the magnetization is inverted for every other magnetic field pole. That is, when the rotor side surface of the permanent magnet 254a is the N-pole, and the shaft side surface of the permanent magnet 254a is the S-pole, the rotor side surface of the adjacent permanent magnet 254b is the S-pole, and the shaft side surface of the adjacent permanent magnet 254b is the N-pole. Further, these permanent magnets 254a and 254b are arranged one after another in the circumferential direction. In the embodiment, eight permanent magnets 254 are evenly arranged to provide the rotor 250 with eight poles.

Keys 255 are provided to protrude from the inner circumferential surface of the rotor core 252 arranged at a given distance in between. Further, a key groove 261 is provided to recess from the outer circumferential surface of the shaft 218. The key 255 is engaged in the key groove 261 by running fit, and thereby rotational torque is transmitted from the rotor 250 to the shaft 218.

The permanent magnet 254 may be embedded in the rotor core 252 after being magnetized, or configured to be inserted in the rotor core 252 before being magnetized and then magnetized by applying strong magnetic field. When magnetized, the permanent magnet 254 becomes a strong magnet. Therefore, when the permanent magnet 254 is magnetized before being fixed to the rotor 250, the strong attraction force between the rotor core 252 is produced during the operation of fixing the permanent magnet 254, thereby interrupting the operation. Further, the strong attraction force may cause the permanent magnet 254 to catch dust such as an iron particle. Therefore, magnetizing the permanent magnet 254 after being inserted in the rotor core 252 improves the productivity of the rotating electrical machine.

Note that, in the description described above, both the rotating electrical machines 200 and 202 are in accordance with the embodiment. However, only one of the rotating electrical machines 200 and 202 may have the configuration according to the embodiment and the other may employ other configuration.

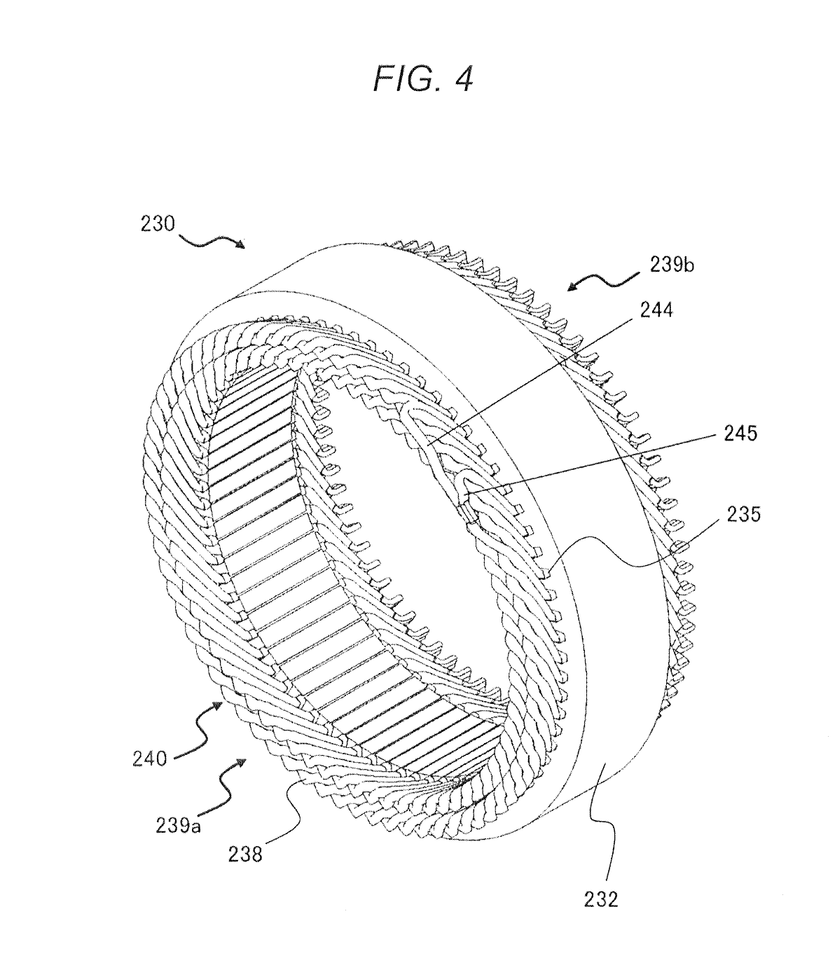

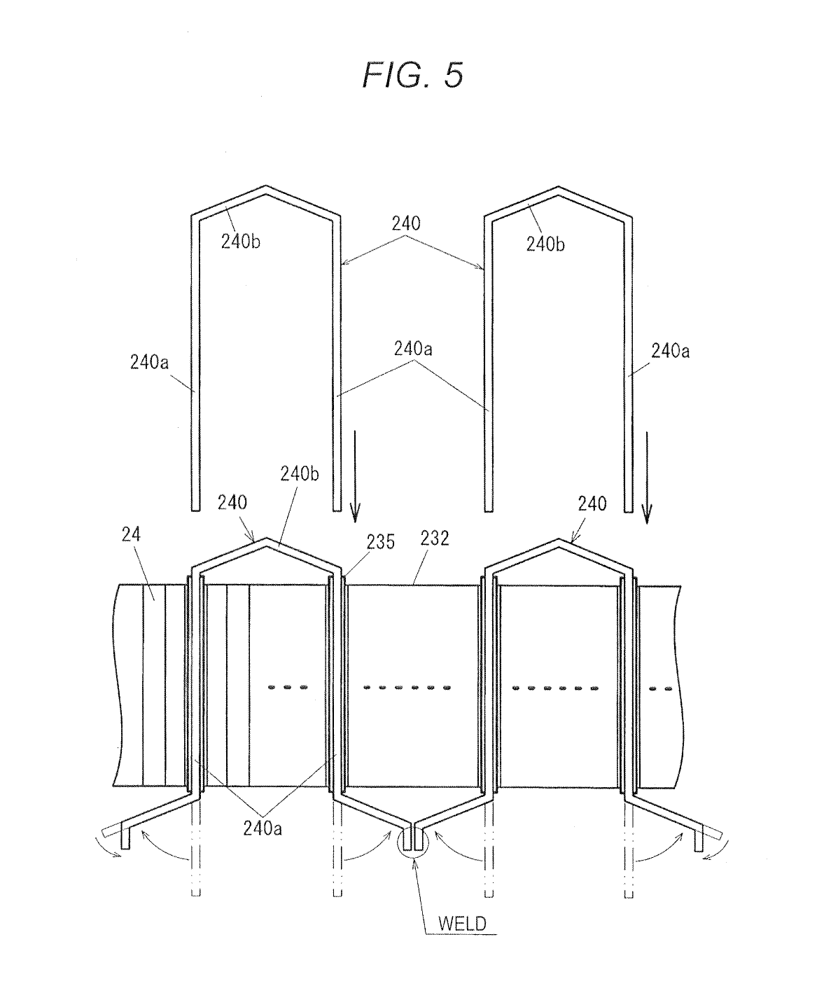

FIG. 4 is a perspective view of the stator 230. A rectangular wire is used for the stator winding 238. In the embodiment, the rectangular wire having a rectangular cross section is previously formed to be a segment coil 240 in which a U-shaped portion 240b, as illustrated in the upper drawing of FIG. 5, is formed using a die or the like. Then, the segment coil 240 is inserted in the slot 24 provided with a slot insulation member 235 along the axial direction. The straight portions 240a of the segment coil 240 are inserted in two separate slots 24 between which a plurality of slots 24 exists. Then, the straight portion 240a protruding to the opposite side in the axial direction of the stator core 232 is twist formed. The end portion of the twist formed portion is welded to an end portion of other segment coil 240 which is twist formed in the similar manner. As described above, by inserting the plurality of segment coils 240 in the slot of the stator core 232 and then by connecting the segment coils together, a single phase winding is formed.

The forming method of the segment coil 240 described above is an example. For example, the forming may also be carried out as described below. After forming the rectangular wire in a simple U-shape, taking either one of the straight portions as a reference, the other straight portion is extended in the circumferential direction for a given distance, and twist formed. After the forming, as in the similar manner, the straight portion is inserted in the slot 24 of the stator core 232 along the axial direction. In this case, the U-shaped portion of the stator winding 238 is formed by twisting, not by a die.

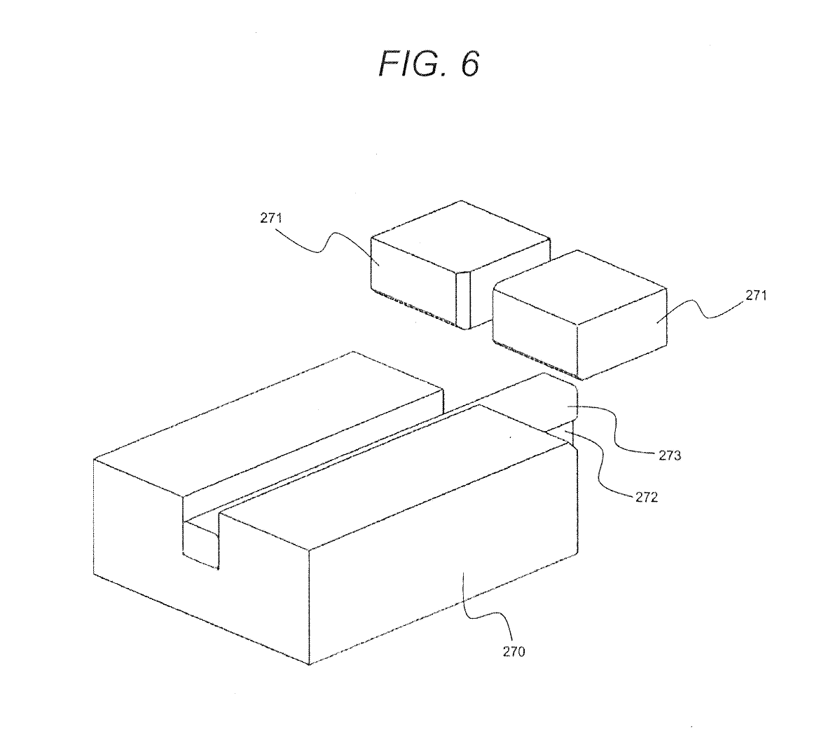

Note that, since an insulation coating such as enamel is applied to the rectangular wire, the insulation coating on the end portion is previously removed by a method illustrated in FIG. 6. There are some methods for removing the insulation coating other than a peeling method by a press as described below. For example, there is a method using chemicals. In the embodiment, the peeling method by a press as described below is used.

In the peeling method illustrated in FIG. 6, when peeling is to be carried out, a rectangular wire 273 formed in a U-shape or a rectangular wire 273 not formed yet is inserted in a guide 270 that fixes the position. An upper die 271 and a lower die 272 are provided at the end of the guide 270. By pressing the upper die 271 downward, the insulation coating together with the conductor portion of the rectangular wire 273 is removed and a peeled portion is formed. In this case, the peeled portion is thinner than a non-peeled portion having the insulation coating. When it is desired that the peeled portion and the non-peeled portion have the same width, the conductor of the peeled portion is pressed, with some degree, to extend the width, and then the extended portion is removed by using a die other than the upper die 271 and the lower die 272 so as to obtain the same width.

As illustrated in FIG. 4, in one side in the axial direction of the stator core 232, a group of coil ends in the welding side 239b is formed. The group of coil ends in the welding side 239b is a circular array of welds on each of which the segment coils 240 are welded together. Further, in the other side in the axial direction of the stator core 232, a coil end 239a constituted with U-shaped portions 240b of a plurality of segment coils 240 is formed. Note that, a lead wire or the like is not illustrated in FIG. 4, in other words, omitted.

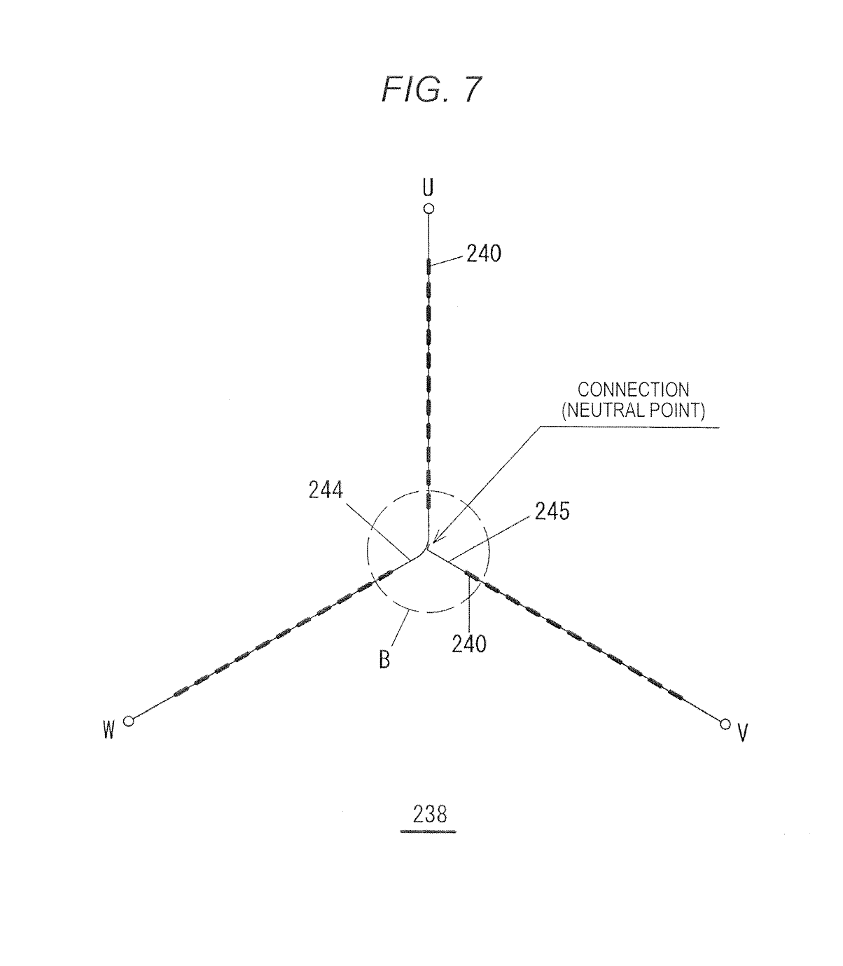

Wires pulled out to the coil end 239a side and appended with reference signs 244 and 245 are neutral wires. The embodiment has a feature in the configuration of these neutral wires 244 and 245. FIGS. 7 to 9 are figures explaining the neutral wires 244 and 245. As illustrated in FIG. 7, the stator winding 238 according to the embodiment is a winding having a single star connection in which a neutral wire of a U-phase winding and a neural wire of a V-phase winding are connected. In the embodiment, the neutral wire of the U-phase winding and a neutral wire of the W-phase winding are formed of a single continuous rectangular wire (hereinafter referred to as “neutral wire 244”), and the neutral wire 245 of the V-phase winding is connected to the neutral wire 244.

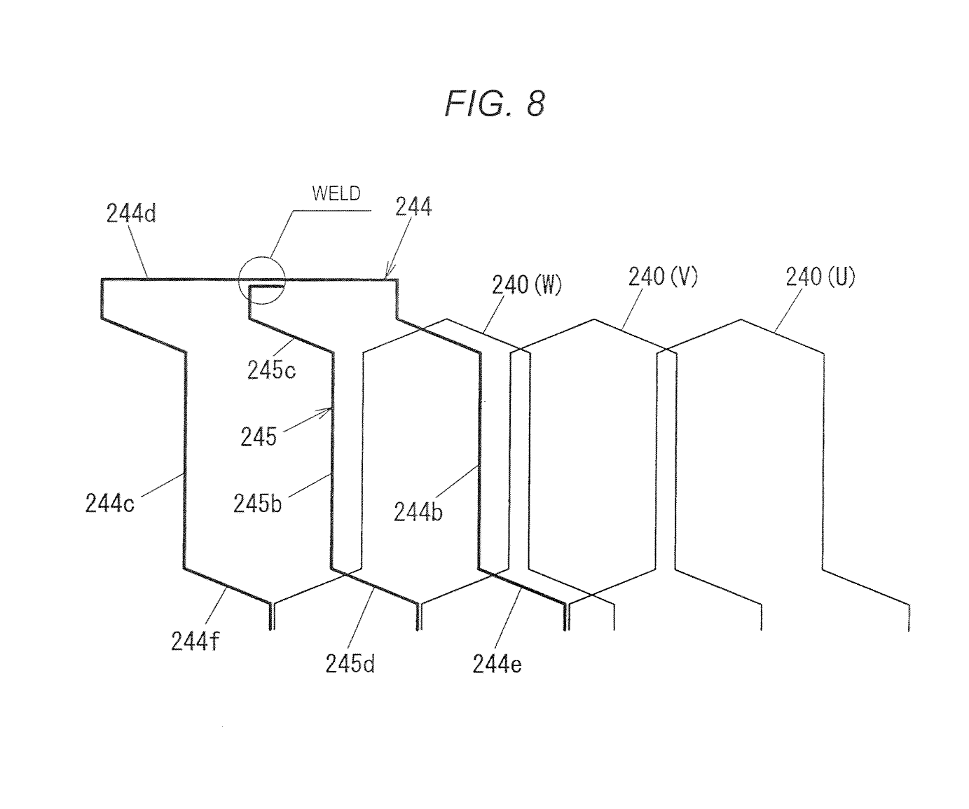

FIG. 8 is a figure illustrating a schematic form of a portion of a winding illustrated in reference sign B in FIG. 7. A segment coil 240 (U) of the U-phase winding is connected to one end of the neutral wire 244 which is a rectangular wire, and to the other end of the neutral wire 244, a segment coil 240 (W) of the V-phase winding is connected. The neutral wire 244 is constituted with straight conductor portions 244b and 244c which are contained in the slot and coil end portions 244d, 244e, and 244f. Further, the segment coil 240 (V) of the V-phase winding is connected to one end of the neutral wire 245, and the other end of the neutral wire 245 is connected to the portion of the coil end portion 244d of the neutral wire 244. The neutral wire 245 is constituted of a straight conductor portion 245b which is contained in the slot 24 and coil end portions 245c and 245d.

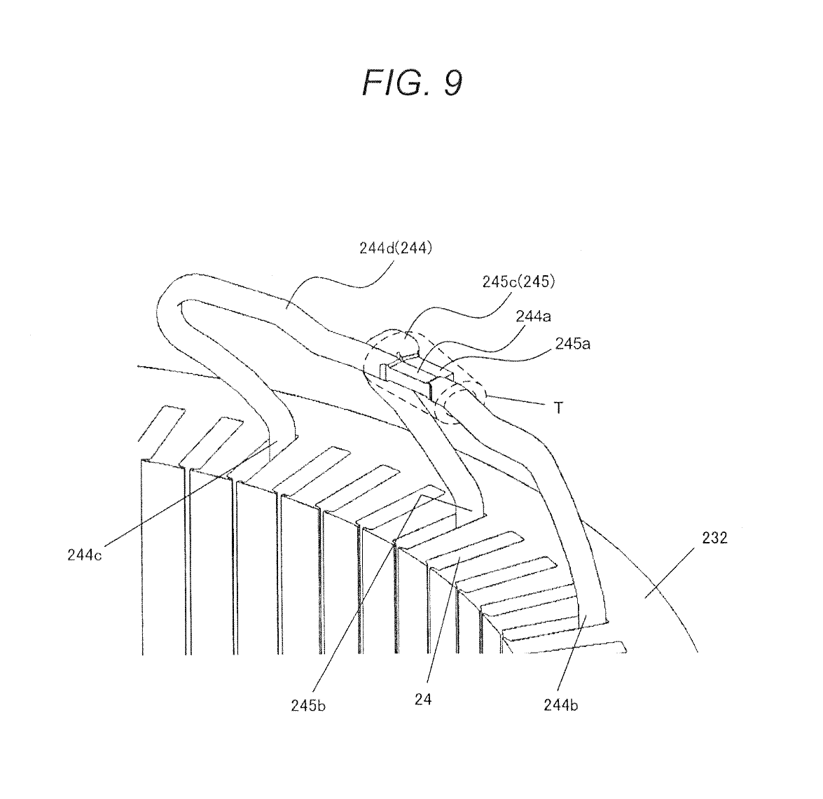

FIG. 9 is a figure illustrating a shape of coil end portions 244d and 245c of neutral wires 244 and 245 pulled out to one end side of the stator core 232. Note that, FIG. 9 illustrates the neutral wires 244 and 245 in the stator winding 238, and illustration of a wire constituting the coil end 239a is omitted. The neutral wire 244 pulled out from the slot 24 in which the straight conductor portion 244c is inserted is routed along the coil end 239a (see FIG. 4), and bent, at an intermediate portion, to the opposite side. Then the bent neutral wire 244 is routed along on the coil end 239a to the opposite direction, and further routed downward along the coil end 239a (see FIG. 4) to enter the slot 24 in which the straight conductor portion 244b is inserted. Further, the neutral wire 245 pulled out from the slot 24 in which the straight portion 245b is inserted is routed along the coil end 239a and then bent to the opposite direction so as to be connected, on the coil end 239a, to the neutral wire 244.

As illustrated in FIG. 9, the insulation coating is removed from the connecting portions 244a and 245a of the neutral wires 244 and 245 by such method as described above. Brazing, TIG welding, or the like is used for connecting the connecting portions 244a and 245a. In the example illustrated in FIGS. 4 and 9, the connecting portions 244a and 245a are arrayed in the radial direction of the stator core 232 to be connected so as to suppress the coil end height.

The insulation coating is peeled, as in FIG. 9, to carry out connection easily. However, peeling is not always necessary. There is a method of removing the insulation coating using chemicals instead of peeling. There is also a method, for example, in which the insulation coating is carbonized and pressed using resistance brazing so that the neutral wires are connected with each other without removing the insulation coating.

Note that, connection of the neutral wires 244 and 245 may be carried out after or before inserting the straight conductor portions 244b, 244c, and 245b illustrated in FIG. 8 in the slot 24 of the stator core 232. In either case, shapes of the neutral wires 244 and 245 are previously formed so as to be routed along the coil end 239a illustrated in FIG. 9.

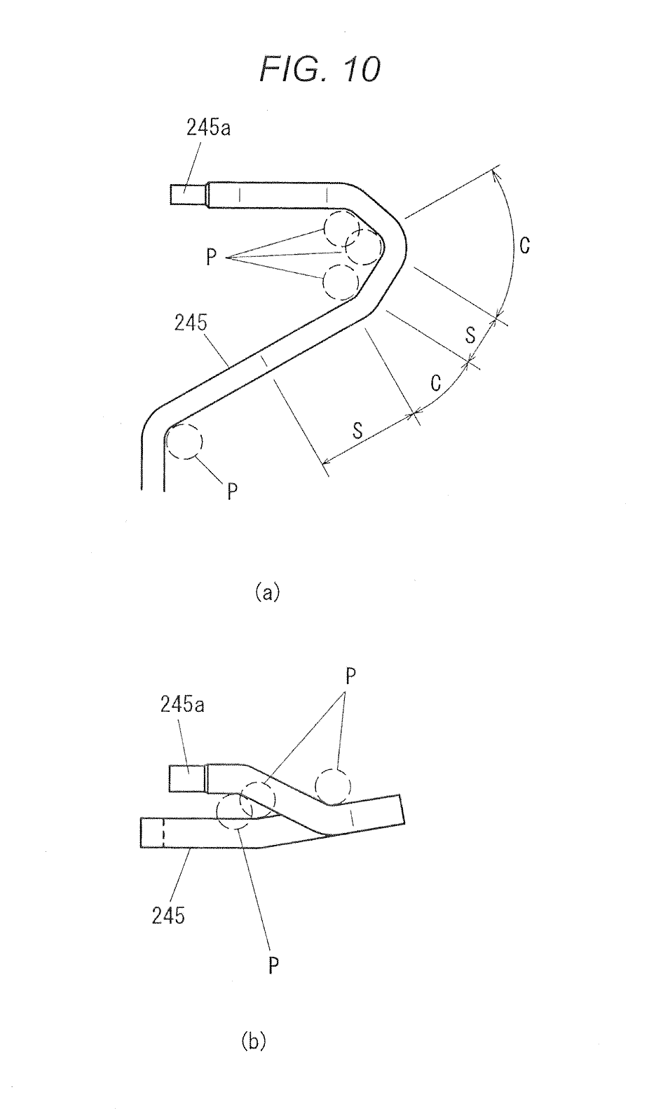

In the forming of the neutral wires 244 and 245, for example, a forming processing as illustrated in FIG. 10 is used. FIG. 10 is a figure illustrating the schematic view of a neutral wire 245 after forming processing. FIG. 10A is a figure of the neutral wire 245 viewed from the side of the stator and FIG. 10B is a figure of the neutral wire 245 viewed from the axial direction. By carrying out forming processing of the rectangular wire using a forming pin P, the neutral wire 245 having a complicated shape as illustrated in FIG. 10 can be formed. Consequently, the neutral wire 245 can be inserted in the slot without interfering with other coils and without being routed outside the side face of the coil end 239a. By the forming processing, the neutral wire 245 is constituted with a straight-shaped portion S and a bend-shaped portion C, and an impression by the forming pin is formed on the surface of the rectangular wire. Naturally, the neutral wire may be constituted not only with the straight-shaped portion S and the bend-shaped portion C but with shapes including an arc-shaped portion. Note that, the neutral wire 244 is constituted in the similar manner.

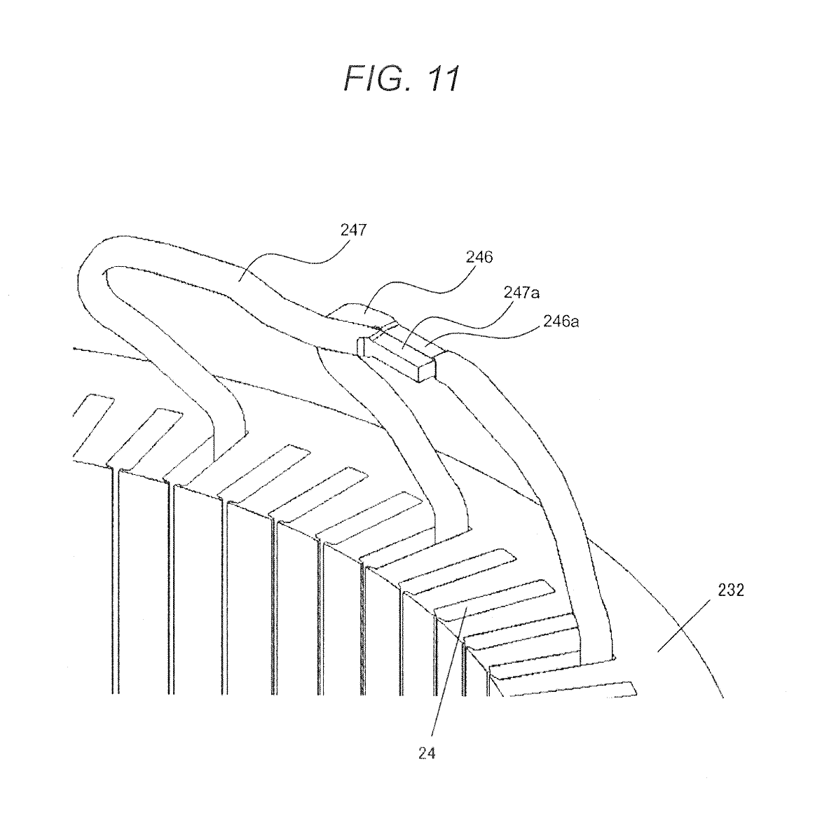

FIG. 11 is a figure illustrating a first exemplary modification. In the first exemplary modification, the neutral wire of the U-phase winding and the neutral wire of the V-phase winding are constituted with a common rectangular wire which is a single neutral wire 246. Further, the connecting portion 247a of the neutral wire 247 of the W-phase winding is configured to be connected to the connecting portion 246a provided in the middle portion of the neutral wire 246. The connecting portions 246a and 247a are arranged to be arrayed in the radial direction in the similar manner to the case of the connecting portions 244a and 245a in FIG. 9.

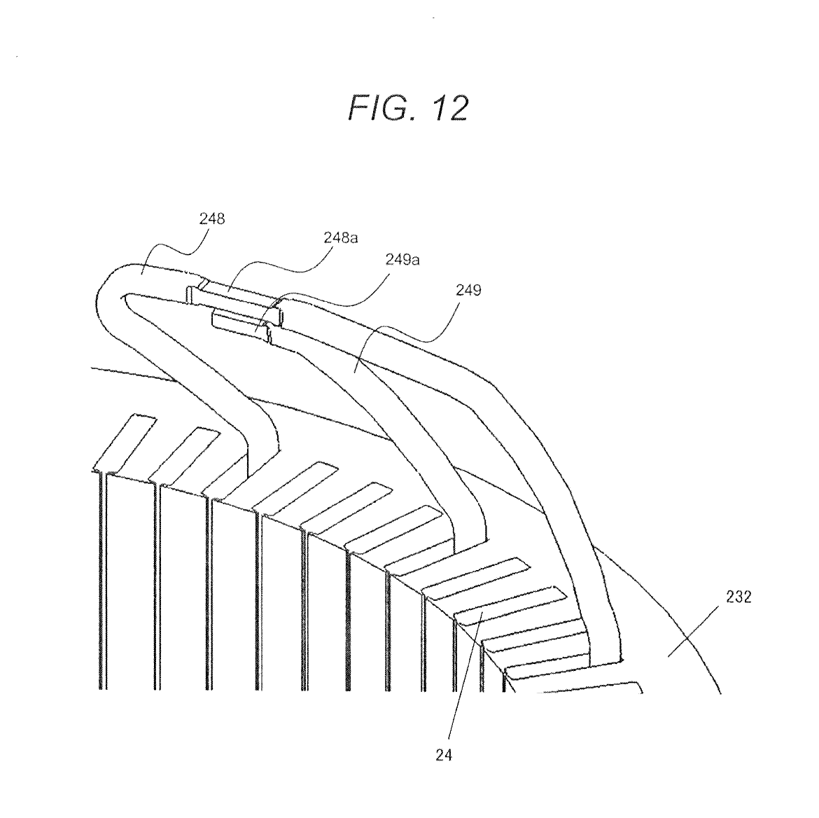

FIG. 12 is a figure illustrating a second exemplary modification. In the second exemplary modification, as in the similar manner to the case in FIG. 7, the neutral wire of the U-phase winding and the neutral wire of the W-phase winding are formed to be a single neutral wire 248. Further, a connecting portion 249a of the neutral wire 249 of the V-phase winding is arranged in the bottom side in the axial direction of the connecting portion of the neutral wire 248, and the connecting portions 248a and 249a are connected. In this case, the coil end height is higher than the case in which the connecting portions are arrayed in the radial direction as in FIG. 4, though the width in the radial direction of the connection can be made smaller. Further, in the form illustrated in FIG. 12, the region which is routed along on the coil end 239a is very small. This not only improves insulation between other coils but also makes the form very simple.

Note that, the connection of the neutral wire (e.g., connecting portions 244a and 245a in FIG. 9) needs to be insulated from other coils. For example, a resin such as varnish or a tubular insulation member (illustrated with dashed line T in FIG. 9) is necessary for covering. However, if sufficient distance between other coil is provided, such measures as mentioned above is not necessary.

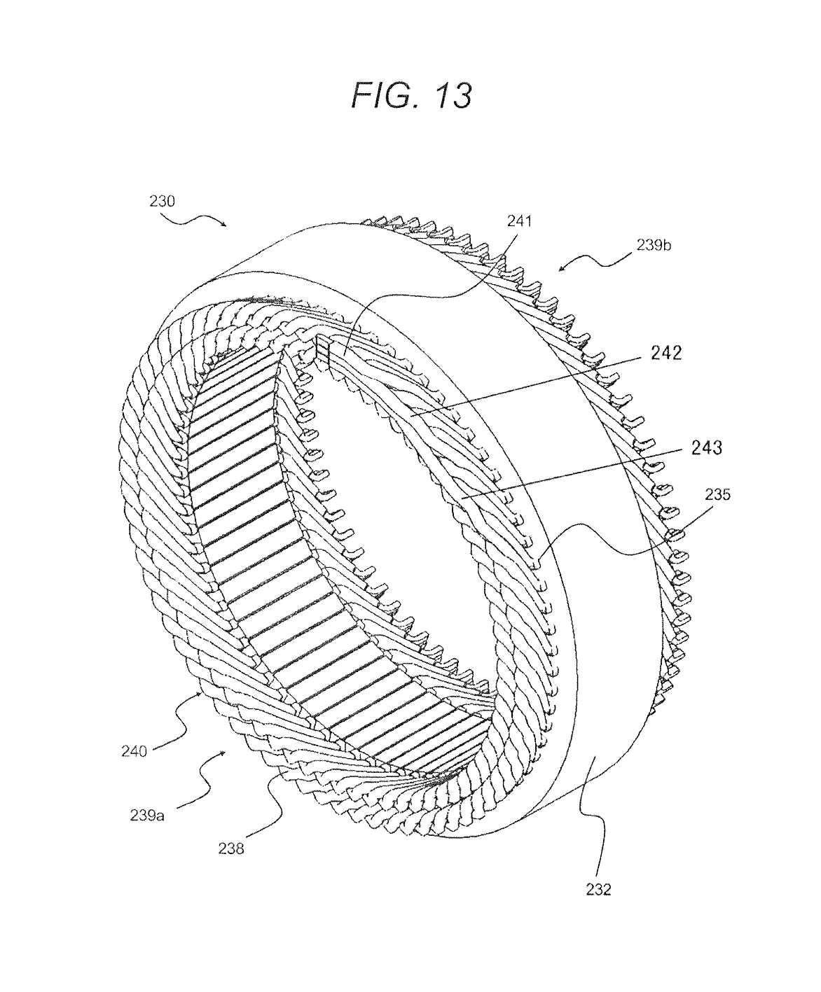

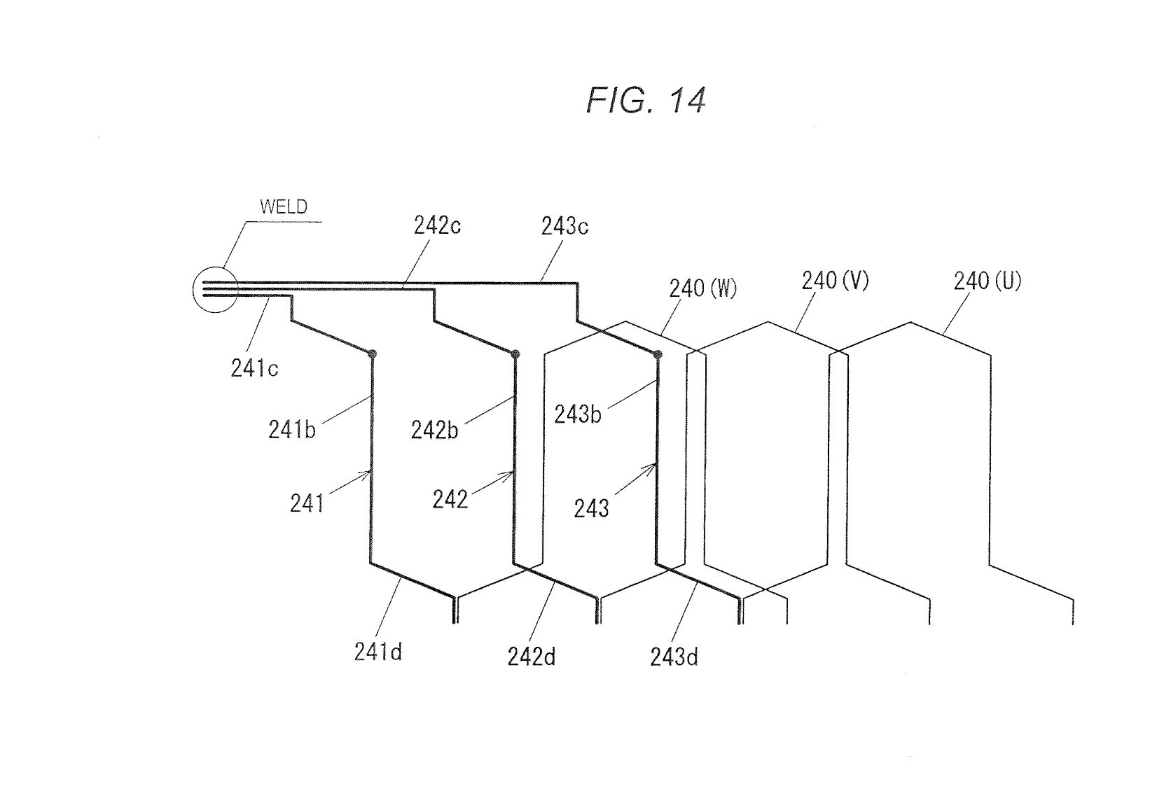

FIGS. 13 and 14 illustrate perspective views of a conventional stator as a comparative example. FIG. 13 corresponds to FIG. 4, and FIG. 14 corresponds to FIG. 8. In FIG. 13, neutral wires 241, 242, and 243 represent, in this order, the neutral wire of the W-phase winding, the neutral wire of the V-phase winding, and the neutral wire of the U-phase winding. The neutral wires 241, 242, and 243 includes, respectively, straight conductor portions 241b, 242b, and 243b, and coil end portions 241c and 241d, 242c and 242d, and 243c and 243d. Each of neutral wires 241, 242, and 243 pulled out from the slot 24 is formed in a shape so as to extend toward the highest point of the coil end 239a along the shape of the U-shaped portion 240b of the segment coil 240 which constitutes the coil end 239a. Further, these connections are connected with brazing or the like at the highest portion of the coil end.

Comparing the structure the connection, in the case of FIG. 13, it is necessary to array three neutral wires 241, 242, and 243 in parallel to connect the neutral wires at once. This deteriorates workability because adjusting the three neutral wires to be aligned at the same height is difficult. Further, in the embodiment illustrated in FIG. 4, the adjustment of locations should be made for two neutral wires 244 and 245, which makes the adjustment of location very easy compared to the case in which the locations of three neutral wires should be adjusted. Thereby, improvement in workability and improvement in reliability of the connection can be provided.

Further, conventionally, three neutral wires 241, 242, and 243 are routed in the same direction to be connected. As is apparent by comparing FIG. 8 and FIG. 14, the length of the neutral wire is longer in the case of the conventional structure. Therefore, the length which needs insulation is longer for the conventional structure. This deteriorates reliability and also increases coil resistance which results in reduction of efficiency.

Further, in the embodiment, the number of neutral wires can be reduced to two, thereby providing decrease in the length of the portion of the neutral wire to be routed along on the coil end 239a and reduction in the number of parts. Further, since the neutral wire 244 combined to be a single wire is inserted in two slots, the adjustment of location of the connection with another neutral wire 245 is easy, so that the connection is easily made. As for the dimension of the width in the radial direction of the connection, the dimension includes a dimension for two rectangular wires in the configuration illustrated in FIGS. 4 and 11, and a dimension for one rectangular wire in the configuration illustrated in FIG. 12. In either case, the dimension in the radial direction can be reduced.

Further, since the length of the total neutral wire is reduced, the amount of coil material to be used can be reduced. Also, since the coil resistance is reduced by the reduction of the coil length, efficiency can be improved. As described above, the stator according to the embodiment, by employing the configuration having such neutral wire configuration as illustrated in FIG. 4, provides improvement in adjustability of location during connection, improvement in insulation of the routed portion, and improvement in efficiency.

The feature of the embodiment described above can be summarized as follows. The stator winding 238 includes the phase windings of the U-phase, the V-phase, and the W-phase, constituted by connecting a plurality of segment coils 240 which are formed in an approximate U-shape. Further, for example, as illustrated in FIGS. 8 and 9, the neutral wire 244 connecting the U-phase winding and the W-phase winding is formed of a single continuous conductor extending across the different slots 24. The neutral wire 245 connecting the neutral wire 244 and the V-phase winding is pulled out from the slot 24 arranged between the two slots mentioned above and connected to the neutral wire 244. Consequently, the embodiment has the configuration in which connecting portions of two neutral wires 244 and 245 are connected. Therefore, adjusting of location is easy compared to the case in which three neutral wires are connected as in the conventional configuration, thereby providing improvement in workability of the connecting operation. Further, since the connection is made at an intermediate location of three slots, the total length of the neutral wire can be reduced, thereby providing improvement in efficiency of the rotating electrical machine.

Note that, in order to further reduce the total length of the neutral wire, pitches between three slots from which the neutral wires 244 and 245 are pulled out are preferably be the same, as illustrated in FIG. 9. Naturally, reduction of length can be provided in a configuration in which the pitches are not the same.

As a method of constituting the neutral wire to be a single continuous conductor, the neutral wire 244 may be provided between the U-phase winding and the W-phase winding as illustrated in FIG. 9. Further, the neutral wire 246 may be provided between the U-phase winding and the V-phase winding as illustrated in FIG. 11. Furthermore, the neutral wire may be provided between the V-phase winding and the W-phase winding, although not shown in the drawing.

Further, when the increase in the height dimension of the coil end due to provision of the connecting portion is to be suppressed, it is preferable to arrange two connecting portions to be arrayed in the radial direction of the stator core 232 as illustrated in FIGS. 9 and 11. When the increase in the width dimension of the coil end is to be suppressed, it is preferable to arrange connecting portions to be arrayed up and down in the axial direction as illustrated in FIG. 12. Naturally, also in the arrangement as illustrated in FIGS. 9 and 11, the dimension in the radial direction is suppressed compared to the conventional configuration in which three connecting portions are arrayed in the radial direction.

Further, by constituting the conductor of the portion pulled out from at least one of the slots of the neutral wires 244 and 245 as illustrated in FIG. 9 with the straight-shaped portion S and the bend-shaped portion C as illustrated in FIG. 10, a complicated shape can easily be formed. Thereby, the neutral wire can be shaped to be route around so as not to contact the coil of the coil end 239a, enabling suppressing the increase in the dimension of the coil end as much as possible.

Note that, the description made above is merely an example. The example does not limit or restrict the correlation between the content of description of the embodiment and the content of the claims on construing the invention. For example, in the embodiment described above, description is made for a stator winding having a single star as an example. However, the present invention is not limited to the single star, and can be applied to a stator winding having a two star connection. Further, description is made for the motor for driving a vehicle as an example. However, the present invention is not limited to the application for driving a vehicle, and can be applied to various kind of motors. Furthermore, the present invention is not limited to motors, and can be applied to various kind of rotating electrical machines such as a generator.

Various embodiments and exemplary modifications are described above. However, the present invention is not limited by the contents of such embodiments and exemplary modifications. Other aspects made within the technical ideas of the present invention are included in the spirit and the scope of the present invention.

The present invention claims priority from the basic application below, the disclosure of which is hereby incorporated by citation.

Japanese Patent Application No. 2011-194885 (applied on Sep. 7, 2011)

1. A stator for a rotating electrical machine comprising:
a stator core including a plurality of slots arrayed in a circumferential direction; and
a stator winding formed of a conductor having a rectangular cross section and an insulation coating, the stator winding configured to be inserted in the slot, wherein
the stator winding includes a first, a second, and a third phase windings configured by connecting a plurality of segment coils formed in an approximate U-shape,
a first neutral wire formed of a single continuous conductor extending across a first slot and a second slot, and configured to connect the first phase winding and the second phase winding, and
a second neutral wire pulled out from a third slot and configured to connect the third phase winding and the first neutral wire.

2. The stator for a rotating electrical machine according to claim 1, wherein
the first and second slots in which the first neutral wire is inserted and the third slot in which the second neutral wire is inserted are arrayed in a circumferential direction in an order of the first slot, the third slot, and the second slot.

3. The stator for a rotating electrical machine according to claim 1, wherein
the first slot and the second slot in which the first neutral wire is inserted and the third slot in which the second neutral wire is inserted are arrayed in a circumferential direction in an order of the first slot, the second slot, and the third slot.

4. The stator for a rotating electrical machine according to claim 1, wherein
the first, the second, and the third slots are arranged with the same slot pitch.

5. The stator for a rotating electrical machine according to claim 1, wherein
a connecting portion of the first neutral wire and a connecting portion of the second neutral wire are arranged so as to be arrayed in a radial direction of the stator core.

6. The stator for a rotating electrical machine according to claim 1, wherein
a connecting portion of the first neutral wire and a connecting portion of the second neutral wire are arranged so as to be arrayed in an axial direction of the stator core.

7. The stator for a rotating electrical machine according to claim 1, wherein
a conductor of a portion, of at least either of the first and the second neutral wires, pulled out from a slot is configured with a straight-shaped portion and a bend-shaped portion.

8. The stator for a rotating electrical machine according to claim 1, wherein
the insulation coating of each connecting portion of the first and the second neutral wires is removed.

9. The stator for a rotating electrical machine according to claim 8, wherein
connecting portions of a first and a second neutral wires are covered with an insulation material.

10. A rotating electrical machine comprising:
the stator for a rotating electrical machine according to claim 1; and
a rotor which is rotatably arranged via a gap with the stator core.
